(19) United States
(12) Patent Application Publication
(10) Pub. No.: US 2014/0124443 A1
(43) Pub. Date: May 8, 2014

(54) Systems and Methods for Integrated Heat Recovery in Thermally Separable Draw Solute Recycling in Osmotically Driven Membrane Processes

(71) Applicant: Robert L. McGinnis, Coventry, CT (US)

(72) Inventor: Robert L. McGinnis, Coventry, CT (US)

(21) Appl. No.: 14/074,197

(22) Filed: Nov. 7, 2013

Related U.S. Application Data
(60) Provisional application No. 61/723,477, filed on Nov. 7, 2012.

(51) Int. Cl. B01D 61/36

(52) U.S. Cl. CPC B01D 61/36
USPC 210/640; 210/180

(57) ABSTRACT

Embodiment methods and systems for the recovery of heat produced from an osmotically driven membrane process (ODMP) are provided. Recovery of heat produced from an osmotically driven membrane process (ODMP) includes performing a draw solute thermal separation method on a first solution stream produced by the ODMP, in which the thermal separation method creates a first vapor stream containing draw solute from the first solution stream and a first liquid stream which is substantially free from the draw solute or which has a lower draw solute concentration than the first solution stream, and directing heat from at least a portion of the first vapor stream to a draw solute thermal separation method performed on a second solution stream from the ODMP.

### RELATED APPLICATIONS

This patent application claims the benefit of priority to U.S. Provisional Patent Application Ser. No. 61/723,477, entitled “Integrated Heat Recovery in Thermally Separable Draw Solute Recycling in Osmotically Driven Membrane Processes” filed on Nov. 7, 2012, the entire contents of which are hereby incorporated by reference.

### FIELD OF THE INVENTION

The present invention relates generally to recovery and reuse of heat during the recycling of solutes by phase change, and more particularly from the dilute draw solution stream and concentrated feed solution stream that are produced in an osmotically driven membrane process (ODMP).

### BACKGROUND

Progress in ODMPs over the last decade has been rapid, in large part due to the development of draw solution solutes that are thermally separable by phase change, including, for example, ammonium salts formed from the combination of ammonia (NH₃) and carbon dioxide (CO₂) in water. These solutes create high osmotic pressures in solution and are rejected by semipermeable membranes, allowing them induce water flux through said membranes, thereby inducing water separation or power. Such solutes may also be easily separable from their solvents by heating the draw solutions to induce a change in phase of the solutes.

The amount of thermal energy necessary to induce the phase change of these solutes is often considerably less than the energy that would be required to achieve a comparable separation by conventional thermal desalination methods. However, thermal desalination methods additionally employ advanced heat recovery methods, such as multi-effect staging, and the use of heat pumps, either using an external heat transfer fluid, or by compression of the vaporized solvent itself (e.g., mechanical vapor compression (MVC)). Use of these heat recovery techniques in thermal desalination processes involving ODMPs may be difficult, however, due to non-idealities in the separations used in ODMP processes. One such non-ideality is found in the fact that draw solutes, for example, ammonia and carbon dioxide, are not separable using current state of the art without some coincident vaporization of solvent during the thermal stripping process. For this reason, the energy input for solute stripping is higher than it would be in an ideal separation of draw solutes. This additionally causes the vapor stream to contain a mixture of gases and water vapor, the composition of which may affect the condensation temperature and total and practical energy recoverable from this vapor stream.

A second non-ideality is found in the fact that the current state of the art membranes used in ODMPs allow some degree of reverse salt flux of draw solutes into the feed stream. The presence of these draw solutes in the feed stream as well as the dilute draw solution stream means that in most cases, the draw solutes must be stripped from both streams. This presents challenges in that the distribution of draw solutes between these streams can vary depending on the operating conditions of the ODMP system, and by the fact that the boiling points of the two streams will often be quite different, due to the differences in the composition of draw solutes (the ratio of ammonia to carbon dioxide, for example), and due to the colligative property of boiling point elevation in the more concentrated brine stream (in the case of forward osmosis and potentially also direct osmotic concentration).

### SUMMARY

The various embodiments provide methods for recovering heat produced from an osmotically driven membrane process including: performing a draw solute thermal separation method on a first solution stream produced by the ODMP, in which the thermal separation method creates a first vapor stream containing draw solute from the first solution stream and a first liquid stream which is substantially free from the draw solute or which has a lower draw solute concentration than the first solution stream; and directing heat from at least a portion of the first vapor stream to a draw solute thermal separation method performed on a second solution stream from the ODMP.

The various embodiment integrated heat recovery systems provided for recycling thermally separable draw solution solutes include: an osmotically driven membrane process (ODMP) system, in which the ODMP system contains a first product stream output and a second product stream output; a first thermal separation apparatus fluidly connected to the ODMP system, in which the first thermal separation apparatus contains a first vapor stream output and outputs a first liquid stream output; a second thermal separation apparatus fluidly connected to the second product stream output, in which the second thermal separation apparatus contains a second vapor stream output and outputs a second liquid stream output; and a first heat exchanger fluidly connected to the first vapor stream output and the second liquid stream output, in which the first heat exchanger is configured to transfer heat from condensation of at least a portion of the first vapor stream output by the first thermal separation apparatus to the liquid stream output of the second thermal separation apparatus.

The various embodiments also provide methods of operating an ODMP system which include: providing a feed stream and a draw solution stream into an ODMP device; providing a diluted draw solution stream to a first thermal separation apparatus; providing a concentrated feed stream to a second thermal separation apparatus; providing a first vapor stream from the first thermal separation apparatus to a first heat exchanger; and providing a second liquid stream from the second thermal separation apparatus to the first heat exchanger, such that the second liquid stream is heated by the first vapor stream in the first heat exchanger.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a schematic of an integrated system to recover and reuse heat input in the thermal recovery of a draw solution solute from output streams of an osmotically driven membrane process, according to an embodiment.

FIG. 2 is a schematic of an integrated system to recover and reuse heat input in the thermal recovery of a draw solution solute from output streams of an osmotically driven membrane process, according to another embodiment.

FIG. 3 is a schematic of an integrated system to recover and reuse heat input in the thermal recovery of a draw solution solute from output streams of an osmotically driven membrane process, according to an embodiment.

### DETAILED DESCRIPTION

The terms “osmotically driven membrane process,” “ODMP” and “ODMP system” are used interchangeably herein to refer generally to processes/systems that use a semi-permeable membrane to effect an osmotic separation of a fluid, such as water, from dissolved solutes, discussed in further detail below.

As used herein, the term “conduit” refers generally to flow pipes and other fluid flow ducts or conduits known to those of ordinary skill in the art for allowing transport of fluid (e.g., vapor and/or liquid) streams to and/or from system components.

The various embodiments provide efficient heat recovery in draw solute recovery mechanisms applied to streams produced by ODMPs, which undergo phase change. Embodiment systems integrate thermal stripping of draw solution solutes from the dilute draw solution and from a feed stream. In the various embodiments, the stripping of draw solution solutes from both the draw and feed streams may involve integrating the operation of draw solute recovery mechanisms, one for each stream, that each involves a thermal separation process for either the draw solution or feed stream. Draw solute recovery mechanisms in the various embodiments involve integrated operation of two draw solute stripping operations corresponding to the feed and draw solution streams. The two draw solute stripping operations may be implemented by any of a variety of thermal separation mechanisms, including, but not limited to, distillation columns, membrane distillation arrays, pervaporation arrays, etc.

The various embodiments may be used to recover draw solute in any of a number of osmotically driven membrane processes (ODMPs). Examples of such ODMPs may include forward osmosis (FO) and/or pressure enhanced osmosis (PEO) desalination or water treatment, pressure retarded osmosis (PRO) power generation, and direct osmotic concentration (DOC) of desired feed stream constituent. In some ODMPs for which the embodiment recovery systems may be used, a first solution (known as a process or feed solution) may be seawater, brackish water, wastewater, contaminated water, a process stream, or other aqueous solution may be exposed to a first surface of the membrane. A second solution (known as a draw solution) with an increased concentration of solute(s) relative to that of the first solution may be exposed to a second opposite surface of the membrane.

In an example system in which the feed solution contains sodium chloride (NaCl), and in which an ammonia-carbon dioxide (NH₃—CO₂) draw solution is used, ammonium ions (NH₄⁺) may move from the second side of the osmosis membrane to the first side of the membrane. Further, sodium ions (Na⁺) may move from the first side of the membrane to the second side. Solvent, such as water, may be drawn by water flux from the first solution through the membrane, thereby concentrating the first stream and diluting the second stream.

The diluted second stream may be collected at a first outlet and undergo a further separation process. In some, purified water may be produced as a product from the solvent-enriched solution. The concentrated first stream may be collected at a second outlet for discharge or further treatment. Such concentrated process solution may contain one or more target compounds which it may be desirable to concentrate or otherwise isolate for downstream use. In the various embodiments the draw solutes may be recovered for reuse.

In the various embodiments, the diluted draw solution stream and concentrated feed stream may be directed to draw solute recovery mechanisms involving separate thermal separation apparatuses (e.g., distillation columns, membranes, pervaporation arrays, etc.). In an embodiment, low temperature heat may cause the draw solutes in a thermal separation apparatus to evaporate, leaving a product water substantially without said solutes. A heat exchanger may be used to condense a portion of the vapors. In at least one embodiment, about 70% of the vapors may be condensed. An absorber system may be used to introduce a portion of the remaining vapors to absorb into a dilute draw solution stream. In at least one embodiment, a second absorber system may use a concentrated ammonia solution to absorb the remaining draw solute vapors. Liquid streams exiting the condenser, and the first and second absorbers, may be mixed and used as all or part of the concentrated draw solution.

Heat may be recovered in the various embodiments using, for example, mechanical vapor compression acting on the vapor streams that are produced by draw solute recovery methods. In other embodiments, the heat recovery may involve closed or semi-open heat pumps using heat transfer fluids commonly employed in heat recovery and refrigeration. In some embodiments, additional thermal energy may be integrated into the thermal stripping of draw solutes from, by way of example, heat recovered from engines used to generate power and/or drive the heat pump apparatuses; heat rejected from other activities close enough to the ODMP operations as to be accessible for such use.

The integrated heat recovery methods transfer latent and/or sensible heat from vapor streams produced during the thermal recovery of volatile draw solution solutes to the thermal recovery operation, such that the draw solution solutes may be reused for the continued recovery of solutes. In the various embodiments, the integrated heat recovery method may involve increasing condensation temperature of the vapor streams such when they are condensed, the amount of heat transferred to a stream with draw solution solute is sufficient to cause vaporization of the solute. By this and methods contained in alternate embodiments, the net energy input to die draw solution solute recycling system may be significantly reduced, compared to such systems that do not employ heat recovery methods.

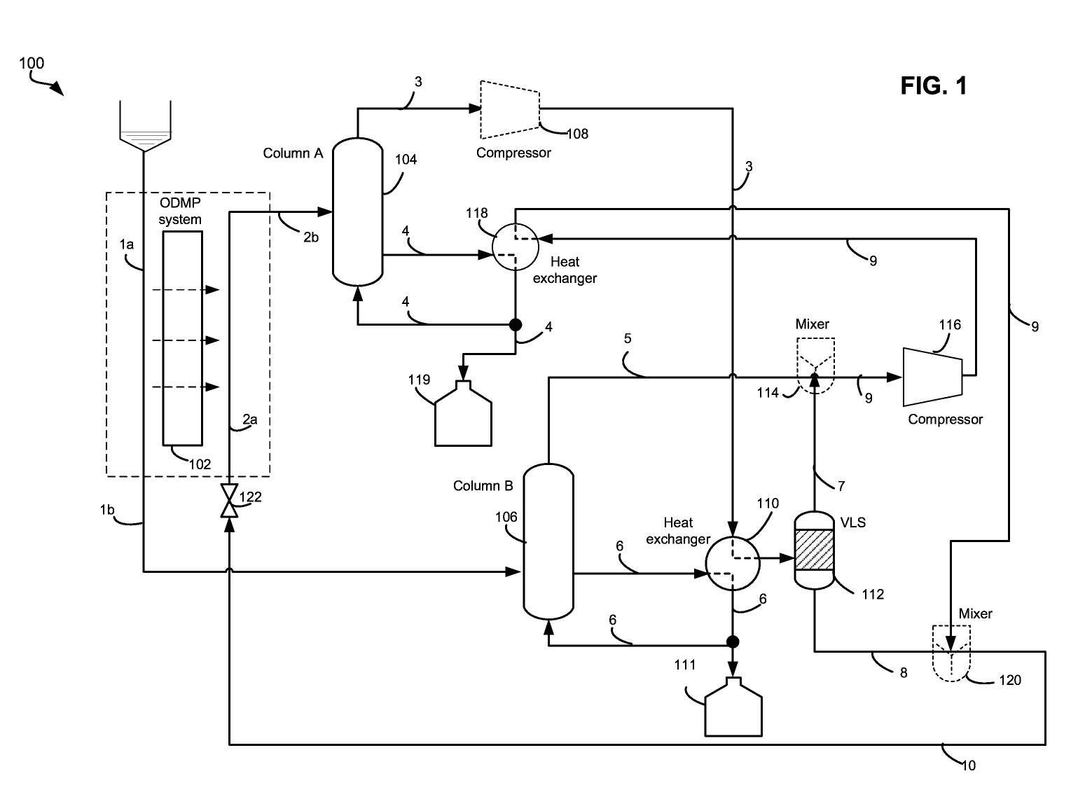

FIG. 1 illustrates an embodiment system for recovering draw solution solutes from product streams and recovering/recycling the heat produced in such solute recovery. System 100 may include an ODMP system, which may be any type of semi-permeable membrane in which water flux is driven from a feed stream to the draw solution stream due to osmotic pressure difference across the membrane (e.g., FO, PRO, PEO, DOC). For example, in a FO membrane system, the feed stream is desalinated in that the water flux through the membrane into the draw solution effectively separates the feed water from its solutes, now concentrated on the side of the feed stream. In a DOC membrane system, the water flux similarly flows from the feed stream, also leaving a concentrated product solute stream, which may be recovered as a target compound. In a PRO membrane system, like the FO and DOC membrane systems, the water flux from the feed stream leaves a concentrated product solute stream. In the PRO system, the initial feed stream may be further substantially unpressurized and diluted.

In all of these illustrations, stream 1 is concentrated, and stream 2 (the draw solution) is diluted, by water flux through the membrane system. In the case of PRO, stream 2 will additionally be pressurized, and subsequently directed to pressure exchangers. While solutes from each stream are substantially rejected from passing the semi-permeable membrane, some amount of solutes from the feed stream may enter the draw solution stream, and solutes from the draw solution stream may enter the feed solution, to varying degrees, depending on the operating conditions of the system. Further, ions from each stream may also cross the membrane, without equal representation by their counter ions, so long as ions of the same charge cross the membrane in the opposite direction, a phenomenon known as membrane ion exchange.

In the various embodiments, the feed solution may be any solution containing solvent and one or more solutes for which separation, purification or other treatment is desired. Example applications for such treatment may include recovery of purified water recovery for downstream use, removal of undesirable solutes from water, concentration and recovery of desired solutes, etc.

In some embodiments, the feed solution may be filtered and pre-treated in accordance with known techniques in order to remove solid and chemical wastes, biological contaminants, and otherwise prevent membrane fouling, prior to osmotic separation. In other embodiments, such as those in which the ODMP uses a DOC system, the feed solution may be a process stream containing one or more solutes, such as target species, which may be desirable to concentrate, isolate, or recover. Such streams may be from an industrial process such as a pharmaceutical or food grade application. Example target species may include pharmaceuticals, salts, enzymes, proteins, catalysts, microorganisms, organic compounds, inorganic compounds, chemical precursors, chemical products, colloids, food products, or contaminants.

The feed solution may be delivered to a forward osmosis membrane treatment system from a source module providing previously-stored feed solution, from an upstream unit operation such as an industrial facility, or from any of a number of other sources, including a salt water body, such as a sea or an ocean. Feed solutions may include various salts and other ionic species such as chloride, sulfate, bromide, silicate, iodide, phosphate, sodium, magnesium, calcium, potassium, nitrate, arsenic, lithium, boron, strontium, molybdenum, manganese, aluminum, cadmium, chromium, cobalt, copper, iron, lead, nickel, selenium, silver, and zinc.

Example feed solutions that may be used in the various embodiments include, but are not limited to, aqueous solutions such as seawater, brine and other saline solutions, brackish water, mineralized water, industrial waste water, and product streams associated with high purity applications, such as those affiliated with the food and pharmaceutical industries.

The draw solution in the various embodiments may be an aqueous solution containing a higher concentration of solute relative to the feed solution. The draw solution may generally be capable of generating osmotic pressure within an osmotically driven membrane system. The osmotic pressure may be used for a variety of purposes, including desalination, water treatment, solute concentration, power generation, and other applications. A wide variety of draw solutions may be used. In some embodiments, the draw solution may include one or more removable solutes. In at least some embodiments, thermally removable (thermolytic) solutes may be used. For example, the draw solution may comprise a thermolytic salt solution. In some embodiments, an ammonia and carbon dioxide draw solution may be used, which may be concentrated. Other solutes that may be used in the draw solution include products of ammonia and carbon dioxide gases, such as ammonium carbonate, ammonium bicarbonate, and ammonium carbamate.

System 100 may implement draw solute recovery mechanisms in Column A 104 and Column B 106, which may be two of the same or different type of a number of types of thermal separation apparatuses. Example solute recovery systems of Column A 104 and Column B 106 may include distillation columns, distillation membranes, pervaporation membranes, and/or other systems that may cause draw solution solutes, such as ammonia and carbon dioxide solutes to be removed by adding heat to the draw solute recovery system and/or adding pressure to the vapors produced in the draw solute recovery system. In an embodiment, distillation columns (e.g., fractionating columns) may be coupled to heat exchangers, such as reboilers and condensers. In another embodiment using a pervaporation membrane, pervaporation materials may include natural or synthetic polymers such as polyurethane or natural rubber, or suspended liquid membranes that act as passive or active selective membranes for ammonia and carbon dioxide relative to water vapor. In some embodiments, a pervaporation or similar membrane separation method may be used in place of or in conjunction with a distillation column. In at least one embodiment, an absorber column may also be implemented as part of the draw solute recovery system in Columns A and B.

System 100 may also include heat exchangers 110, 118, such as reboiler heat exchangers. The heat exchangers may include heating and cooling devices that can be electrical heaters, refrigeration units, solar collectors, and heat exchangers such as steam condensers (described below), circulators and so forth, such as are well known in the art. The heating and cooling devices, along with any other equipment used within the process that may have power requirements, can derive their energy from any variety of commonly used sources, including, for example, waste steam, solar energy, wind or geothermal energy, and conventional sources.

In some embodiments, the system 100 may also include one or more compression devices, such as mechanical vapor compression devices 108, 116 acting directly on the vapor stream(s) of the draw solute recovery methods. In other embodiments, the compression devices may be closed or semi-open heat pumps using heat transfer fluids commonly employed in heat recovery and refrigeration. Other combinations of thermal and/or mechanical heat pumps may be employed in conjunction with multiple distillation column staging, either conventional or membrane based, so as to best balance the desire to increase the number of stages while minimizing equipment costs. These may include, for example, a thermocompressor on one or more columns, a mechanical compressor on one or more other columns, and other heat pump types on other columns, as needed, as well as integration between heat streams as might benefit an absorption heat pump implementation where heat absorbed at a low temperature may deliver a smaller quantity of heat at a higher temperature.

Compressors 108, 116 in the various embodiments may be used in some embodiments such that the remaining vapor stream may be compressed to raise its pressure and thereby increase the absorption kinetics. In some embodiments, the recycling system may further include a compression operation downstream of the absorber to enhance condensation of draw solute gases. Example components that may be used to perform compression operations include, without limitation, gas compressors, steam eductors, liquid stream eductor, etc. Alternatively, compressor 108 may be omitted.

In other embodiments, a steam jet may be used in which a small portion of steam may be mixed with vapors to increase pressure to an intermediate pressure between the two streams. In still other embodiments, an absorbing solution may be pressurized and introduced into an eductor jet to entrain and compress the solute vapor. In one or more embodiments, an absorber with series flow of vapors and series or parallel flow of absorbent may be used in various configurations, using membrane contactors, packing within a column, or similar equipment. In one embodiment, series flow of vapor may be coupled with parallel flow of absorbent that has been cooled, such that no cooling need take place within the absorbing device. In other embodiments, cooling may take place in the device. A heat exchange area as well as a mass interface area may both be in a single device.

Optionally, mixers (e.g., mixers 114, 120) may be included in embodiments of the systems to mix various fluid (e.g., vapor and/or liquid) streams. Mixers may be, for example, static mixers, high shear mixers, dispersion mixers, vacuum mixers, etc. In embodiments in which vapor and/or liquid streams to be mixed have different pressures, mixers may be devices that operate by the Venturi effect (e.g., eductors, thermocompressors, etc.) and are capable of mixing constituent streams that have different pressures.

Any materials may be used to construct the various holding and/or storage devices (chambers, vessels, and receptacles), conduits, piping, and related equipment, as long as they will withstand the weight of the solutions, and be nonreactive with any solutes within the solutions. Typical materials are non-corrosive, non-reactive materials such as stainless steel, plastic, polyvinyl chloride (PVC), fiberglass, and so forth. The vessels can take any suitable configuration, but are typically cylindrical tanks, contoured or fitted tanks, and so forth. The receptacles are typically water towers, cylindrical tanks, contoured or fitted tanks, and so forth. As discussed above, it is important to note that the chambers are shown as separate units, but the invention is not limited to that configuration, and where appropriate, any number of chambers can be contained within a single vessel, for example, partitioned into two chambers separated by the semi-permeable membrane 102.

Operation of system 100 may involve various steps to optimize heat recovery and reuse from the recovery of draw solutes. Osmotic pressure difference across the membrane 102 may cause water to flow from the feed solution in conduit 1 on the first side of the membrane to the draw solution in conduit 2 on the second side of the membrane. As a result, the ODMP system may produce a concentrated feed stream in conduit 1b on the first output side of the membrane and a diluted draw solution in conduit 2b on the second output side of the membrane. In an embodiment that uses a PRO system, the diluted draw solution in conduit 2b may be pressurized and directed to subsequent pressure exchangers (not shown).

The diluted draw solution in conduit 2b may be direct to a first thermal separation apparatus (e.g., Column A) 104, which may recover draw solutes for reuse the system 100. The concentrated feed stream in conduit 1b may be directed to a second thermal separation apparatus (e.g., Column B) 106, which may recover any reverse salt flux of draw solute that passed from the initial draw solution stream in conduit 2a to the initial feed solution stream in conduit 1a. Columns A and B may use any one or more thermal separation techniques.

In Column A 104, draw solution solutes in the dilute draw solution stream may be vaporized, thereby separating the draw solution solutes in outlet conduit 3 from a remaining water stream in outlet conduit 4 that is substantially free from draw solution solutes. In Column B 106, any draw solute in concentrated feed stream in inlet conduit 1b may also be recovered by vaporization, thereby producing draw solute vapor and water vapor in outlet conduit 5 and a water stream in outlet conduit 6 that is concentrated in the solutes of the feed stream but substantially free from draw solutes. In this embodiment, Column A operates at a higher pressure than Column B. In alternate embodiments, the pressures may be same or reversed, as suits the concentrations of solutes in stream 1 and 2 and the operating conditions of the ODMP.

The vapors in conduit 3 may be directed to an optional compressor 108, which may increase the vapor pressure and thereby raise their condensing temperature. The vapors in conduit 3 and the water stream in conduit 6 may be directed to the heat exchanger 110. In the heat exchanger 110, heat may be transferred from the vapors provided via conduit 3 to water provided via conduit 6 in the form of latent heat of vaporization released from the condensation of at least a portion of the vapors from conduit 3. Such heat may be applied to vaporize at least a portion of the water stream from conduit 6, which may in turn be reused in the thermal separation process in Column B. In other words, conduit 6 recycles the heated water (e.g., water vapor) from heat exchanger 110 back into the inlet of Column B 106. The remaining liquid in the stream in conduit 6 may be collected, such as in a vessel 111, and may be reused with or without modification in the ODMP system. For example, the stream in conduit 6 may be used as the brine waste stream of a FO process, concentrated product of a DOC process, or recombined with the feed solution stream in conduit 1a. In this manner, a portion of the heat used in Column A 104 may be recycled for use in Column B 106. In other words, the vapor outlet stream from Column A is used to heat a water outlet stream from Column B. The at least partially condensed vapors from conduit 3 may be directed from heat exchanger 110 to a vapor liquid separator (VLS) 112, which may produce vapor in output conduit 7 and liquid in output conduit 8.

Returning to Column B 106, the vaporized draw solution solutes and water vapor in conduit 5 may be combined with the vapor in conduit 7 from the VLS 112 to produce a combined vapor stream in conduit 9. This stream combination may be performed using a mixer 114, which may be any of various types of mixers known in the art. The combined vapor stream in conduit 9 may be compressed in a compressor 116, thereby raising the condensation pressure of the combined vapor stream in conduit 9. The combined vapor stream in conduit 9 may be directed from the compressor 116 to the heat exchanger 118. The heat exchanger 118 may cause condensation of at least part of the combined vapor stream from conduit 9, from which latent and/or sensible heat may be transferred to vaporize at least a portion of the water stream from conduit 4 produced from the thermal draw solute recovery process in Column A 104. The resulting at least partially vaporized stream in conduit 4 may be reused in the thermal recovery process in Column A 104, thereby recycling of heat used in Column A and B to Column A. Thus, the vapor outlet streams from Columns A and B may be used to heat the water outlet stream from Column A. In other words, the water outlet of heat exchanger 118 may be recycled into the inlet of Column A. The remaining liquid stream in conduit 4 may be collected in a vessel 119 and may be used in the ODMP system. For example, the collected liquid in vessel 119 may be used as the product water of an FO process, the removed solvent of a DOC process, or the working fluid of a PRO process.

The at least partially condensed combined stream in conduit 9 may be combined with the liquid stream in outlet conduit 8 from the VLS 112 to form a concentrated draw solution in conduit 10. Such combination may be produced by mixer 120. The solution in conduit 10 may be recycled, with or without modification, to create the initial draw solution in conduit 2a which is provided to the membrane 102. Such recycling of the concentrated draw solution in conduit 10 may be controlled through a valve 122.

Embodiments of the heat recovery system 100 may provide several advantages over other systems and methods. One advantage may be that, since vapor in Column A 104 may be subjected to a higher pressure than that of Column B 106, a larger quantity of heat may be required for the separation process in Column A 104 compared to the heat required in Column B 106. As such, the first transfer of heat for reuse to Column B 106 may be down a pressure gradient, and thus more efficient. That is, the less vapor from the higher pressure Column A 104 that is required to condense to transfer the latent heat to Column B 106, the less work may be required in Compressor A 104.

Another advantage may be that the composition of the solutes in the feed solution may be such that they are less soluble at higher temperatures, thereby making the lower pressure and temperatures of Column B 106 relative to Column A 104 effective in reducing precipitation in conduit 1b or Column B 106.

Another advantage may be that due to the lower concentration of draw solution solutes in the vapor separated in Column B 106, the vapor stream in conduit 5 may have a higher condensing temperature that of the compressed vapor in conduit 3 and that of the vapor in conduit 7 produced from operation of the VLS 112. Therefore, the vapor stream 9 resulting from mixing the vapor stream in conduit 5 with the vapor stream in conduit 7 may require a lower degree of compression to achieve latent heat transfer to Column A 104, thereby requiring less work by compressor 116.

In an embodiment that uses compressor 108 in addition to compressor 116, another advantage may be that the heat exchanger 110 may serve as an intercooler, reducing sensible heat of the at least partially vaporized stream in conduit 3 that may result due to compression by compressor 108. Due to the reduced heat, the volume of the vapor stream 7 exiting the VLS 112, and in turn the volume of the combined vapor stream 9, may be reduced, thereby reducing the amount of work required to be performed by compressor 116.

In an embodiment that uses compressor 108 in addition to compressor 116, another advantage may be a reduction in the cost of each compressor 108, 116, since the required compression ratio and temperatures of operation of each compressor 108, 116 may be minimized by splitting the total compression work.

In alternative embodiments, the difference in pressures between Column A 104 and Column B 106, and the concentrations of the feed stream in conduit 1b and draw solution in conduit 2b, may be such that no compressor is required in order to transfer heat between the separated vapor in conduit 3 and liquid in conduit 4. Therefore, system 100 may be configured to include only one compressor 116, omitting optional compressor 108. In such embodiments, the work required for heat reuse in Column A 104 may be provided solely by compressor 116.

These alternative embodiments of the heat recovery system 100 may provide several advantages over other systems and methods. One advantage may be in reducing system complexity by requiring only one compressor.

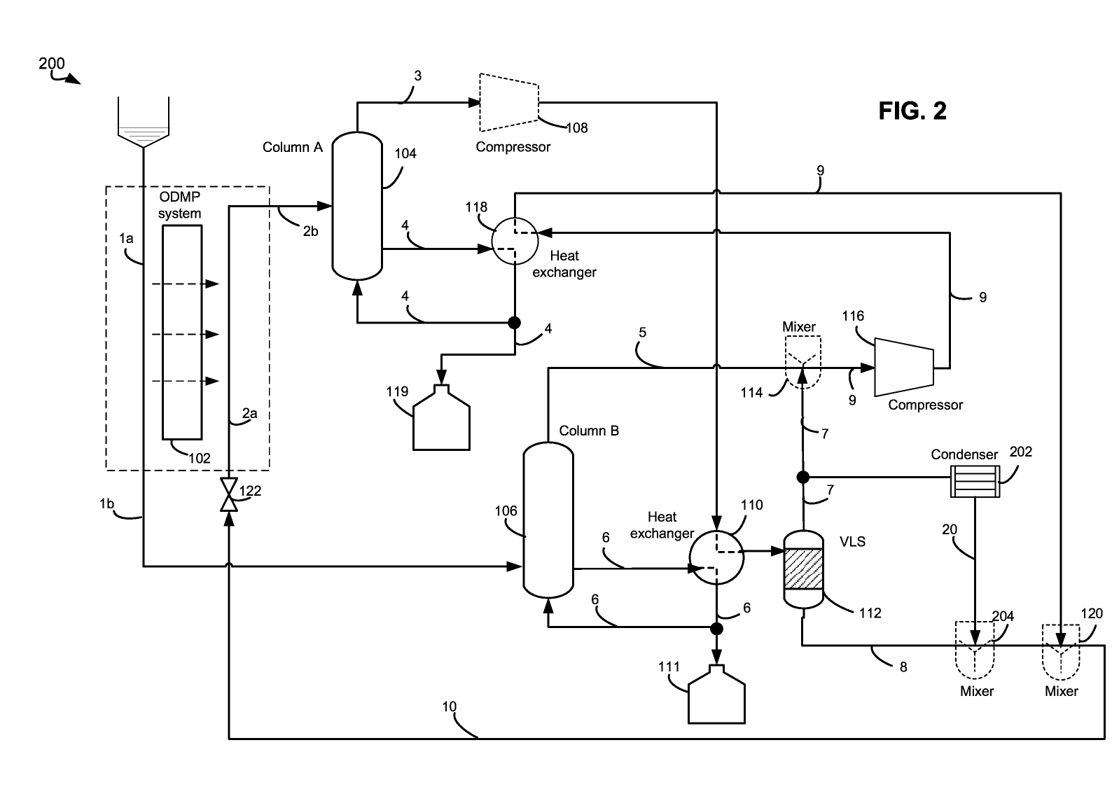

FIG. 2 illustrates another example heat recovery system 200. System 200 may be substantially the same as that of system 100, but may adjust the composition of the combined vapor stream in conduit 9 by providing a bypass of all or a portion of the vapor in conduit 7. In particular, system 200 may include a flow divider, or other connection capable of splitting one stream into two flow paths, to direct the vapor in conduit 7 to a cooling apparatus, such as a condenser 202. The vapor in conduit 7 may be fully condensed into a condensate stream in conduit 20, thereby reducing the volume and draw solute concentration of the combined vapor stream in conduit 9. The condensed vapor in conduit 20 may be combined with the liquid stream in conduit 8 from the VLS 112. Optionally, the condensed streams in conduits 20 and 8 may be mixed in mixer 204, which may be any of the various types of mixers known in the art.

Embodiments of system 200 may provide several advantages over other systems and methods. One advantage may be a reduction in the amount of work to be performed by compressor 116 due to the reduced volume of the combined vapor stream in conduit 9. Another advantage may be that, since the lower concentration of draw solutes correlates with a higher condensing temperature than the vapor streams in conduit 3 and/or the vapor output in conduit 7 from the VLS 112. In this manner, mixing the vapor in conduit 7 with the vaporized volute stream in conduit 5, such as using a mixer 114, may result in a lower degree of compression required to achieve latent heat transfer to Column A 104.

Some embodiments of system 200 may include an optional compressor 108. In alternative embodiments, optional compressor 108 may be omitted as unnecessary based on factors including the relative pressures of Column A 104 and Column B 106, the concentrations of the feed stream in conduit 1b and draw solution in conduit 2b, etc.

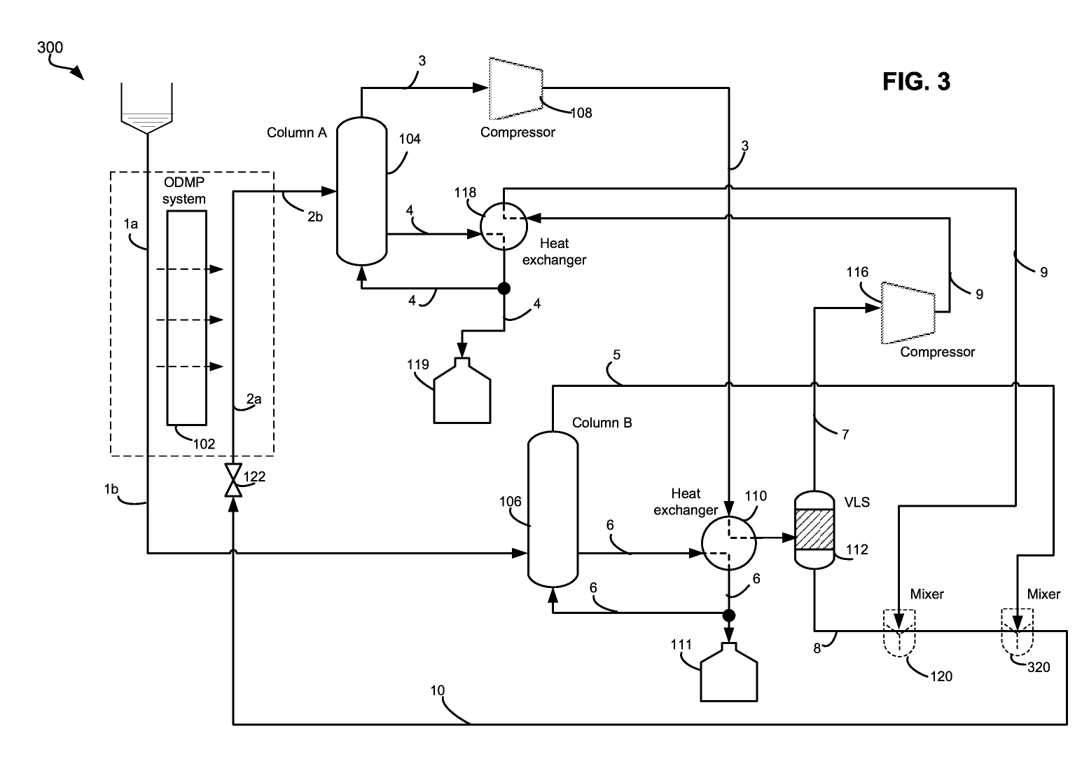

FIG. 3 illustrates another example heat recovery system 300. System 300 may be substantially similar to systems 100 and 200, but may change the interaction between the vaporized solutes in conduit 5, recovered in the separation process in Column B 106, and the additional vapor stream in conduit 7, produced by the VLS 112.

In various embodiments of system 300, the vaporized solute stream in conduit 5 may be kept separate from the vapor stream in conduit 7. In contrast to the embodiment systems 100, 200 in which the heat exchanger 110 may provide heat for Column B which may be directed for reuse in Column A 104, in system 300 the heat exchanger 110 transferring heat into Column B 106 may act only as an interchange cooler for vapor streams directed to heat reuse in Column A 104 (e.g., heat exchanger 118). In an embodiment, the vaporized solute stream in conduit 5 may be optionally directed to the optional condenser 202 (shown in FIG. 2) to be condensed i, and may then be directed to a mixer 320 to be mixed with the liquid stream in conduit 8 produced by the VLS 112. Optionally, the liquid stream in conduit 8 may have also been combined with the at least partially condensed stream in conduit 9 generated from operation of the heat exchanger 118. Thus, the vapor outlet stream from Column B is not used to heat the water outlet stream in the embodiment system 300.

Embodiments of system 300 may provide several advantages over other systems and methods. One advantage may be that the heat exchanger 110, acting as an intercooler, may reduce the sensible heat from compression in compressor 108, and thereby reduce the temperature and volume of the vapor stream in conduit 7 produced by the VLS 112. Due to the reduction in volume, the amount of work needed to be performed by compressor 116 may be reduced. Further, as discussed above with respect to the embodiments of systems 100, 200, one advantage from using compressor 108 in addition to compressor 116 may be reduction in cost of each compressor 108, 116, since the required compression ratio and temperatures of operation of each compressor 108, 116 may be lowered as a result of splitting the total compression work.

In various alternative embodiments of systems 100, 200, 300, the roles of Column A 104 and Column B 106 may be reversed with respect to the feed solution and draw solution. In other embodiments, additional compressors or additional compressor stages may be applied to the vapor streams of the draw solute recovery processes in Column A 104 and/or Column B 106.

As is understood in the art, not all equipment or apparatuses are shown in the figures. For example, one of skill in the art would recognize that various holding tanks and/or pumps may be employed in the present method.

The foregoing method descriptions and the process flow diagrams are provided merely as illustrative examples and are not intended to require or imply that the steps of the various embodiments must be performed in the order presented. As will be appreciated by one of skill in the art the steps in the foregoing embodiments may be performed in any order. Words such as “then,” “next,” etc. are not intended to limit the order of the steps; these words are simply used to guide the reader through the description of the methods. Although process flow diagrams may describe the steps as a sequential process, many of the steps can be performed in parallel or concurrently.

Any reference to claim elements in the singular, for example, using the articles “a,” “an” or “the” is not to be construed as limiting the element to the singular.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method of recovering heat produced from an osmotically driven membrane process (ODMP) comprising:
performing a draw solute thermal separation method on a first solution stream produced by the ODMP, wherein the thermal separation method creates a first vapor stream containing draw solute from the first solution stream, and a first liquid stream which is substantially free from the draw solute or which has a lower draw solute concentration than the first solution stream; and
directing heat from at least a portion of the first vapor stream to a draw solute thermal separation method performed on a second solution stream from the ODMP.

2. The method of claim 1, further comprising:
increasing the condensation temperature of the first vapor stream.

3. The method of claim 2, wherein:
increasing the condensation temperature of the first vapor stream comprises using a heat pump to compress the first vapor stream.

4. The method of claim 3, wherein the heat pump uses an external heat transfer fluid.

5. The method of claim 1, wherein:
performing the draw solute separation method on the second solution stream creates a second vapor stream containing draw solute from the second solution stream and a second liquid stream substantially free from the draw solute or which has a lower draw solute concentration than the second solution stream,
the second liquid stream is a water product-loop feeding stream;
the heat released from condensation of at least a portion of the first vapor stream causes vaporization of at least a portion of the second liquid stream; and
the vaporized second liquid stream is recycled to the draw solute thermal separation method performed on the second solution stream.

6. The method of claim 5, further comprising:
directing an at least partially condensed product stream from the condensation of at least a portion of the first vapor stream to a vapor liquid separator.

7. The method of claim 6, further comprising:
combining vapor from the vapor liquid separator with the second vapor stream in a venturi mixer, wherein the vapor from the vapor liquid separator and the second vapor stream have different pressures, and wherein a combined vapor stream is produced from the combination.

8. The method of claim 7, further comprising:
increasing the condensation temperature of the combined vapor stream; and
directing heat released from condensation of the combined vapor stream to the draw solute separation method performed on the first solution stream from the ODMP.

9. The method of claim 8, wherein the combined vapor stream is compressed prior to the condensation of the combined vapor stream.

10. The method of claim 1, wherein:
the first solution stream comprises a draw solution, the second stream solution comprises a feed water stream, and the second stream solution contains draw solute molecules due to reverse salt flux in the ODMP.

11. The method of claim 1, wherein the ODMP is a forward osmosis process, a pressure retarded osmosis process, or a direct osmotic concentration process.

12. The method of claim 1, wherein the draw solute thermal separation method performed on the first solution stream comprises a distillation process, a membrane distillation process, or a pervaporation process.

13. The method of claim 1, wherein the draw solute thermal separation method performed on the second solution stream comprises a distillation process, a membrane distillation process, or a pervaporation process.

14. An integrated heat recovery system for recycling thermally separable draw solution solutes, comprising:
an osmotically driven membrane process (ODMP) system, wherein the ODMP system contains a first product stream output and a second product stream output;
a first thermal separation apparatus fluidly connected to the first product stream output, wherein the first thermal separation apparatus contains a first vapor stream output and a first liquid stream output;
a second thermal separation apparatus fluidly connected to the second product stream output, wherein the second thermal separation apparatus contains a second vapor stream output and a second liquid stream output; and
a first heat exchanger fluidly connected to the first vapor stream output and the second liquid stream output, wherein the first heat exchanger is configured to transfer heat from condensation of at least a portion of a first vapor stream output by the first thermal separation apparatus to a liquid stream output of the second thermal separation apparatus.

15. The integrated heat recovery system of claim 14, further comprising:
a first compression apparatus fluidly connected to the first vapor stream output of the first thermal separation apparatus.

16. The integrated heat recovery system of claim 15, wherein:
the first compression apparatus comprises a heat pump.

17. The integrated heat recovery system of claim 16, wherein the heat pump contains an external heat transfer fluid.

18. The integrated heat recovery system of claim 14, further comprising a recycle conduit which connects the second liquid stream output of the heat exchanger to input of the second thermal separation apparatus.

19. The integrated heat recovery system of claim 18, further comprising:
a vapor liquid separator that is fluidly connected to a condensed product stream output of the first heat exchanger.

20. The integrated heat recovery system of claim 19, further comprising:
a venturi mixer fluidly connected to the vapor liquid separator output and to the second vapor stream output of the second thermal separation apparatus.

21. The integrated heat recovery system of claim 20, further comprising a second compression apparatus fluidly connected to an output of the venturi mixer.

22. The integrated heat recovery system of claim 14, wherein:
the ODMP system comprises a pressure retarded osmosis membrane system, a pressure retarded osmosis membrane system, or a direct osmotic concentration system; and
the first and second thermal separation apparatuses each comprise a distillation column, a membrane distillation array, or a pervaporation membrane array.

23. A method of operating an ODMP system, comprising:
providing a feed stream and a draw solution stream into an ODMP device;
providing a diluted draw solution stream from the ODMP device to a first thermal separation apparatus;
providing a concentrated feed stream from the ODMP device to a second thermal separation apparatus;
providing a first vapor stream from the first thermal separation apparatus to a first heat exchanger; and
providing a second liquid stream from the second thermal separation apparatus to the first heat exchanger, such that the second liquid stream is heated by the first vapor stream in the first heat exchanger.

24. The method of claim 23, further comprising recycling the second liquid stream into the second thermal separation apparatus.

25. The method of claim 23, wherein:
the first thermal separation apparatus outputs the first vapor stream containing a draw solute and a draw solute free or reduced draw solute first liquid stream; and
the second thermal separation apparatus outputs a draw solute containing second vapor stream and the second liquid stream which is draw solute free or contains reduced draw solute.

26. The method of claim 25, further comprising:
providing the second vapor stream and the first liquid stream to a second heat exchanger to heat the first liquid stream; and
recycling the first liquid stream to the first thermal separation apparatus.

27. The method of claim 25, further comprising:
providing the first vapor stream to a vapor liquid separator after the first heat exchanger;
mixing at least a portion of vapor from the vapor liquid separator with the second vapor stream;
providing the mixed stream to a second heat exchanger; and
recycling the mixed stream output from the second heat exchanger into the draw solution stream.

28. The method of claim 27, further comprising:
providing at least a portion of the vapor from the vapor liquid separator to a condenser; and
recycling a condensate stream output from the condenser into the draw solution stream.

29. The method of claim 25, further comprising recycling the second vapor stream into the draw solution stream.

30. The method of claim 29, further comprising:
providing the first vapor stream output from the first heat exchanger into a vapor liquid separator;
providing vapor from the vapor liquid separator into a second heat exchanger to heat the first liquid stream; and
recycling at least partially condensed vapor output from the second heat exchanger into the draw solution stream.

31. The method of claim 23, further comprising providing the first vapor stream from the first thermal separation apparatus to a compressor prior to providing the first vapor stream to the first heat exchanger.
